(19) United States
(12) Patent Application Publication
(10) Pub. No.: US 2025/0150760 A1
(43) Pub. Date: May 8, 2025

(54) LOUDSPEAKERS

(71) Applicant: SHENZHEN SHOKZ CO., LTD., Shenzhen (CN)

(72) Inventors: Chaojie CUI, Shenzhen (CN); Lei ZHANG, Shenzhen (CN)

(73) Assignee: SHENZHEN SHOKZ CO., LTD., Shenzhen (CN)

(21) Appl. No.: 19/014,180

(22) Filed: Jan. 8, 2025

Related U.S. Application Data
(63) Continuation of application No. PCT/CN2023/072656, filed on Jan. 17, 2023.

(51) Int. Cl. H04R 9/02; H04R 9/04; H04R 9/06

(52) U.S. Cl. CPC H04R 9/027; H04R 9/046; H04R 9/06

(57) ABSTRACT

Embodiments of the present disclosure provide a loudspeaker including a magnetic circuit assembly and a coil assembly. At least a portion of the coil assembly is provided in a magnetic gap formed by the magnetic circuit assembly, and the coil assembly is electrified to drive a vibrating member to vibrate to produce sound. The coil assembly includes a coil support and a coil. The coil support has an extended end extending toward the magnetic gap, and the extended end has a first step structure. The coil includes an outer coil and an inner coil. The outer coil and the inner coil form a second step structure in a direction close to the coil support. The first step structure and the second step structure are fitted to each other so that the coil is fixedly mounted on the coil support.

### CROSS-REFERENCE TO RELATED APPLICATIONS

This application is a continuation of International Application No. PCT/CN2023/072656, filed on Jan. 17, 2023, the contents of which are hereby incorporated by reference.

### TECHNICAL FIELD

The present disclosure relates to the field of electrical devices, and in particular, to loudspeakers.

### BACKGROUND

Coil supports are always bonded to coils in existing loudspeakers. However, a bonding area between a coil support and a coil is not large enough, the coil is easily misaligned or detached from the coil support due to frequent vibrations, which results in inadequate reliability of a loudspeaker. Additionally, a space utilization between the coil support and the coil is low, and a sensitivity needs to be improved.

Therefore, it is desirable to provide a loudspeaker with high sensitivity and good reliability from the perspective of optimizing a configuration and materials of the coil support and the coil.

### SUMMARY

One of the embodiments of the present disclosure provides a loudspeaker including a magnetic circuit assembly and a coil assembly. At least a portion of the coil assembly may be provided in a magnetic gap formed by the magnetic circuit assembly, and the coil assembly may be electrified to drive a vibrating member to vibrate to produce sound. The coil assembly may include a coil support and a coil. The coil assembly may have an extended end extend toward the magnetic gap, and the extended end may have a first step structure. The coil may include an outer coil and an inner coil. The outer coil and the inner coil may form a second step structure in a direction close to the coil support, and the first step structure and the second step structure may be fitted to each other so that the coil may be fixedly mounted on the coil support.

In some embodiments, a height of the inner coil may be greater than a height of the outer coil along an extension direction of the coil support.

In some embodiments, a height of the inner coil may be less than a height of the outer coil along an extension direction of the coil support.

In some embodiments, a width of the inner coil may be the same as a width of the outer coil along a radial direction.

In some embodiments, a width of the outer coil may be greater than a width of the inner coil along a radial direction.

In some embodiments, the coil may be a metal wire with an elongation of no less than 20%.

In some embodiments, the coil may include a conductor, an insulating layer, and an adhesive layer, respectively, in a radial direction of the coil from inside to outside, and a sum of a thickness of the insulating layer and a thickness of the adhesive layer may be not less than 0.016 mm.

In some embodiments, a step parameter H₁ and a height position parameter H₂ of the coil may satisfy H₁+0.5 mm≤H₂≤1.8 mm. The step parameter H₁ may be ½ of a height difference between the inner coil and the outer coil along an extension direction of the coil support. The height position parameter H₂ may be a distance between a reference plane and a top portion of the coil support back away from an alignment direction. The reference plane may be a plane where ½ of the height difference between the inner coil and the outer coil along the extension direction of the coil support is located.

In some embodiments, the step parameter H₁ may be within a range of 0.1 mm-0.8 mm.

In some embodiments, the height position parameter H₂ may be within a range of 1.1 mm-1.6 mm.

In some embodiments, a distance between a lower step surface of the coil support and a top portion of the coil support back away from an alignment direction may be not less than 0.5 mm.

In some embodiments, the magnetic circuit assembly may include a first magnet and a magnetic guide cover disposed at least partially around the first magnet. Along the extension direction of the coil support, a distance between a bottom portion of the coil and a bottom surface of an interior of the magnetic guide cover may be not less than 0.9 mm.

In some embodiments, a gap between the coil and the first magnet in a radial direction may be within a range of 0.25 mm-0.35 mm.

In some embodiments, the magnetic circuit assembly may further include a second magnet and a magnetic guide plate, the magnetic guide plate may be disposed between the first magnet and the second magnet, and the first magnet and the second magnet may be of opposite magnetic properties.

Another embodiment of the present disclosure provides a loudspeaker including a magnetic circuit assembly and a coil assembly. A portion of the coil assembly may be provided in a magnetic gap formed by the magnetic circuit assembly. The coil assembly may be electrified to drive a vibrating member to vibrate to produce sound. The coil assembly may include a coil support having an extended end extending toward the magnetic gap and a coil including an outer coil and an inner coil. The outer coil and the inner coil may form a step structure in a direction close to the coil support, and the coil may be a metal wire with an elongation of no less than 20%.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and where:

FIG. 1 is a schematic diagram illustrating exemplary modules of a loudspeaker according to some embodiments of the present disclosure;

FIG. 2 is a schematic diagram illustrating an exemplary loudspeaker according to some embodiments of the present disclosure;

FIG. 3 is a schematic diagram illustrating another exemplary loudspeaker according to some embodiments of the present disclosure;

FIG. 4 is a schematic diagram illustrating another exemplary loudspeaker according to some embodiments of the present disclosure;

FIG. 5 is a schematic diagram illustrating another exemplary loudspeaker according to some embodiments of the present disclosure;

FIG. 6 is a curve illustrating a relationship between a coil driving force factor BL and a height position parameter H₂ for different step parameters H₁ according to some embodiments of the present disclosure;

FIG. 7 is a cross-sectional view in a radial direction of a coil according to some embodiments of the present disclosure; and

FIG. 8 is a schematic diagram illustrating a coil arrangement according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

Embodiments of the present disclosure provide a loudspeaker. The loudspeaker includes a magnetic circuit assembly and a coil assembly. At least a portion of the coil assembly is provided in a magnetic gap formed by the magnetic circuit assembly. The coil assembly is electrified to drive a vibrating member to vibrate to produce sound. The coil assembly includes a coil support. The coil support has an extended end extending toward the magnetic gap, and the extended end has a first step structure. The coil assembly further includes a coil. The coil includes an outer coil and an inner coil. The outer coil and the inner coil form a second step structure in a direction close to the coil support. The first step structure and the second step structure are fitted to each other so that the coil is fixedly mounted on the coil support. In the present disclosure, by providing the step structures at the extended end of the coil support and the coil, a bonding area between the coil support and the coil may be increased, which further improves bonding firmness and bonding reliability. Furthermore, optionally or additionally, the coil is made of a high-tensile wire having a self-fusing layer (e.g., a copper alloy wire with an elongation of not less than 20%), which can ensure that a bonding strength inside the coil and a bonding strength between the coil and the coil support, further improving the bonding reliability.

When the coil is electrified in a magnetic field, a Lorentz force on each electrical charge at a microscopic level is given by equation (1):

$${F}_{q} = quB \qquad ( 1 )$$

where F_{q} denotes the Lorentz force; q denotes a charge; u denotes a movement velocity of an electrical charge; B denotes a magnetic flux density at a point. Assuming that the electrical charges in an electrified straight wire are uniformly distributed and the electrical charges are moving at a same speed, a current in the electrified straight wire is given by equation (2):

$$I = nqSu \qquad ( 2 )$$

where I denotes the current in the electrified straight wire; n denotes the charge per unit volume; S denotes a cross-sectional area of the electrified straight wire. A macroscopic Ampere force generated by electrifying a straight wire is calculated by the following equation (3):

$$F = nqSLuB = BIL \qquad ( 3 )$$

where F denotes the macroscopic Ampere force; and L denotes a length of the straight wire. For a uniform multi-turn electrified coil, the microscopic total Lorentz force thereon is calculated by the following equation (4):

$$F = \int {uB}_{r} dQ = \int u {B}_{r} \times nqdV = \int \frac{n q u {S}_{0}}{{S}_{0}} {B}_{r} dV = \int \frac{1}{{S}_{0}} {B}_{r} dV \qquad ( 4 )$$

where S₀ denotes a cross-sectional area of a single wire; and Bᵣ denotes a radial flux density modulus at each point of the coil. Setting the cross-sectional area of the coil to be A and a count of windings of the coil to be N₀, then

$${S}_{0} = \frac{A}{{N}_{0}} .$$

The coil driving force actor BL is calculated according to equation (5):

$$B L = \frac{F}{I} = \int \frac{{N}_{0}}{A} {B}_{r} dV . \qquad ( 5 )$$

The count of windings and the cross-sectional area of the coil are constants for a specific shaped coil. Simulation calculations therefore only require volume partitioning of Bᵣ in a coil region, and dividing by the cross-sectional area of a single coil wire S₀ to obtain the value of the coil driving force factor BL. The coil driving force factor BL may reflect the sensitivity of the coil, and the larger the coil driving force factor BL is, the greater the sensitivity of the coil.

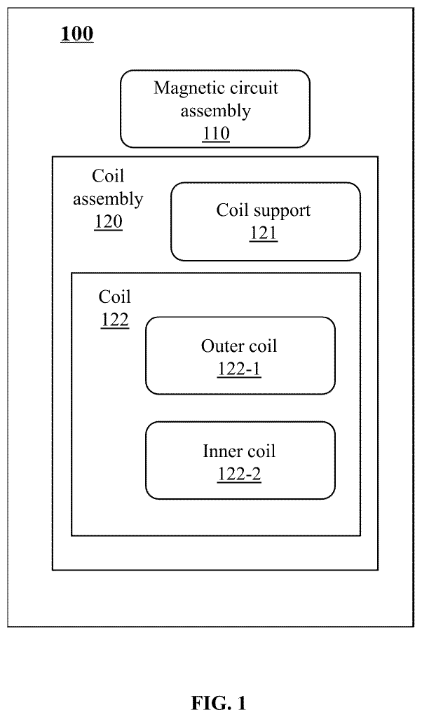

FIG. 1 is a schematic diagram illustrating exemplary modules of a loudspeaker according to some embodiments of the present disclosure.

As shown in FIG. 1, the loudspeaker 100 may include a magnetic circuit assembly 110 and a coil assembly 120.

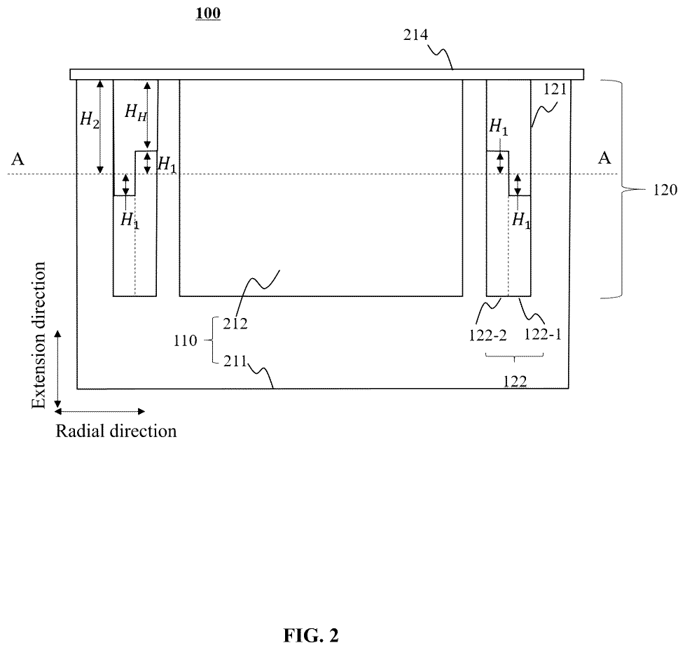

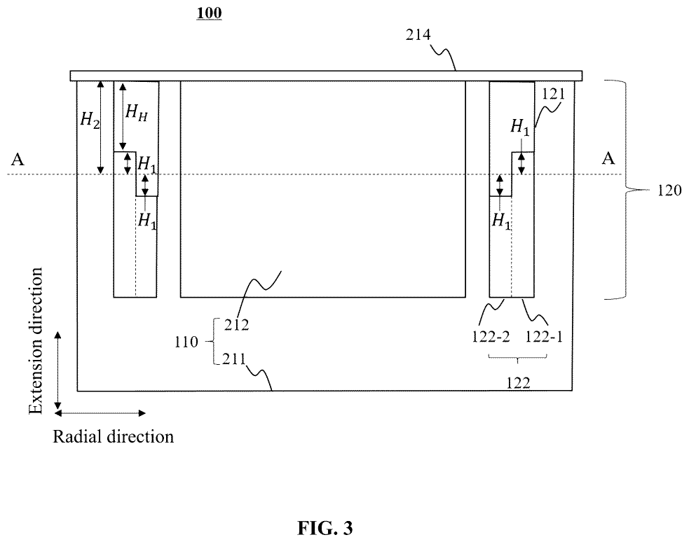

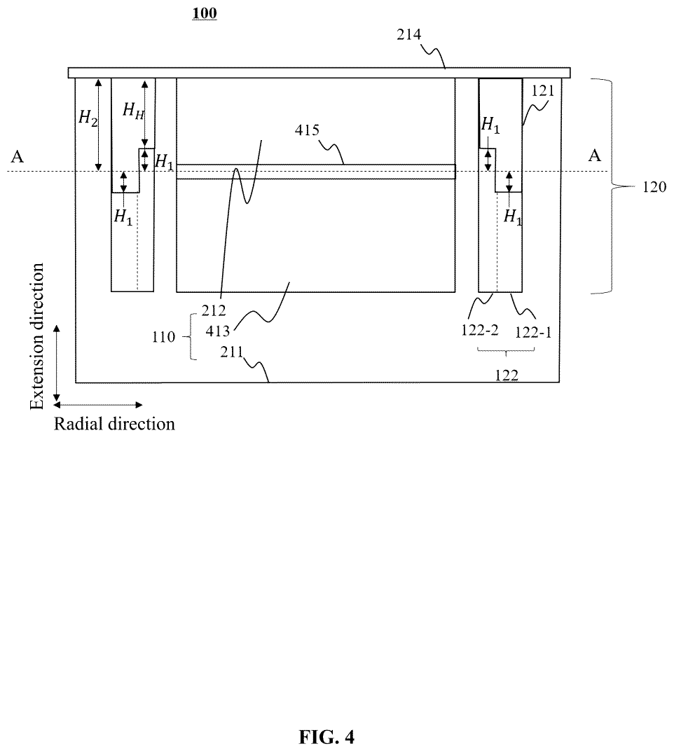

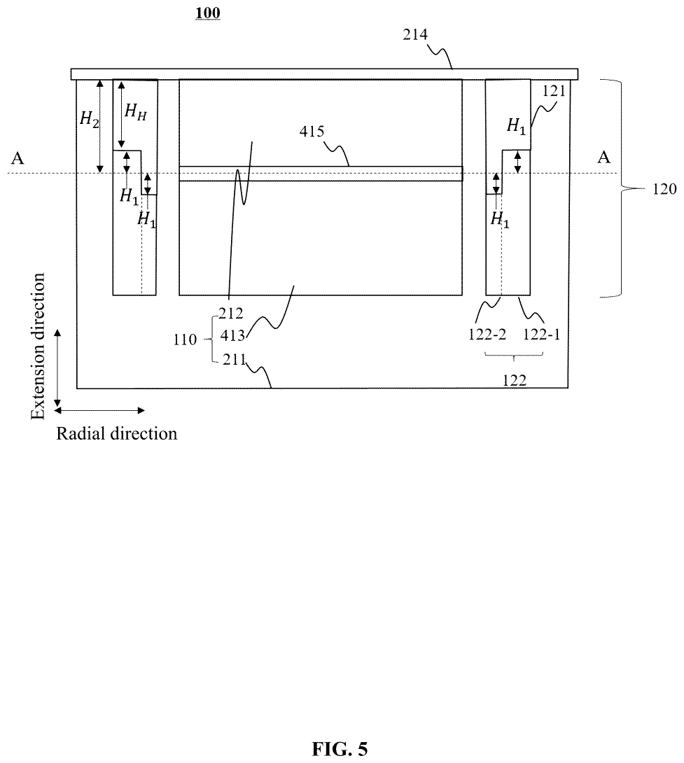

The magnetic circuit assembly 110 may be configured to generate a magnetic field in space and to cause a portion of the coil assembly 120 to be provided in the magnetic field. In some embodiments, the magnetic circuit assembly 110 may include a permanent magnet and other components that have magnetic conductivity. For example, the magnetic circuit assembly 110 may include a magnet, a magnetic guide cover, and a magnetic guide plate. Specific descriptions regarding the magnetic circuit assembly 110 may be found in FIG. 2, FIG. 3, FIG. 4, FIG. 5, and related descriptions thereof. In some embodiments, a magnetic gap may be formed in the magnetic circuit assembly 110.

The coil assembly 120 may be configured to generate vibrations. At least a portion of the coil assembly 120 is provided in a magnetic gap formed by the magnetic circuit assembly 110, and the coil assembly 120 is electrified to drive a vibrating member to vibrate to produce sound. For example, the coil assembly 120 is electrified to generate an Ampere force under the action of an external magnetic field, such as the magnetic field generated by the magnetic circuit assembly 110, and the direction of the Ampere force is determined according to a left-hand rule. The coil assembly 120 may include a coil support 121 and a coil 122.

The coil support 121 may be configured to support the coil 122. The coil support 121 has an extended end extending toward the magnetic gap, and the extended end has a first step structure. In some embodiments, the coil support 121 may be in the shape of a torus, a hollow cylinder, a hollow ellipsoid, or the like. The space in the center of the coil support 121 may be used to accommodate at least a portion of the magnetic circuit assembly 110. For example, the space in the center of the coil support 121 may accommodate the magnet, the magnetic guide plate, or the like.

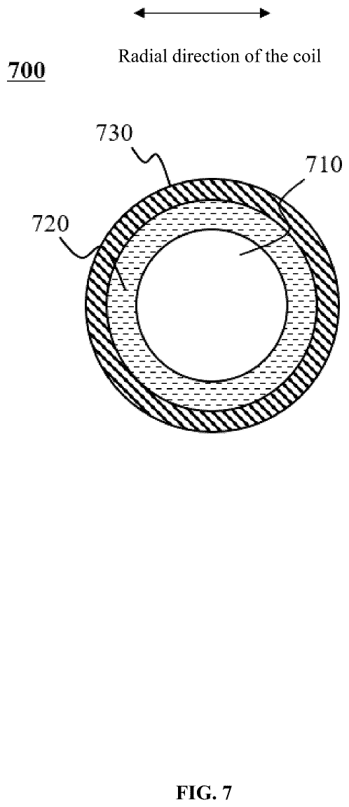

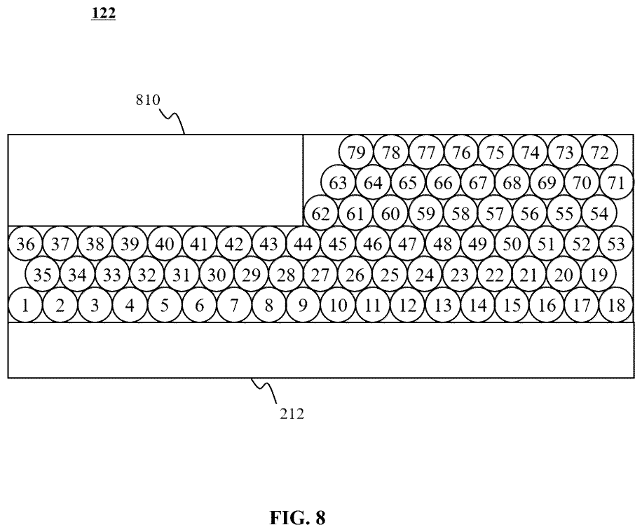

The coil 122 may generate an Ampere force in response to an electrified current and the external magnetic field and produce damping during vibration. The coil 122 may include an outer coil 122-1 and an inner coil 122-2. In a direction close to the coil support 121, the outer coil 122-1 and the inner coil 122-2 form a second step structure. The first step structure and the second step structure are fitted to each other so that the coil 122 is fixedly mounted on the coil support 121. It should be appreciated that what is described herein with respect to a fitted connection between the two step structures means that each step in one of the step structures is fitted to one step of the other step structure that are in contact with each other and two opposing step surfaces are in contact with each other. For example, each step in the first step structure is fitted to one step in the second step structure and two opposing step surfaces are in contact with each other. Specific descriptions regarding the first step structure and the second step structure may be found in FIG. 2, FIG. 3, FIG. 4, FIG. 5, and their related descriptions. In some embodiments, the wire of the coil 122 may be an enameled wire, for example, a copper wire with an insulating layer, an aluminum wire, or the like. Descriptions regarding the coil 122 may be found in FIG. 7 and its related description. In some embodiments, the coil 122 may be wrapped around the coil support 121. Descriptions regarding the coil 122 being wrapped around the coil support 121 may be found in FIG. 8 and its related description.

FIG. 2 is a schematic diagram illustrating an exemplary loudspeaker according to some embodiments of the present disclosure.

As shown in FIG. 2, the loudspeaker 100 may include a magnetic circuit assembly 110, a coil assembly 120, and a vibration transmitting sheet 214. The magnetic circuit assembly 110 may include a magnetic guide cover 211 and a first magnet 212. The coil assembly 120 may include a coil support 121 and a coil 122. The coil 122 further includes an outer coil 122-1 and an inner coil 122-2. An extension direction shown in FIG. 2 refers to a direction in which the coil support 121 butts up against the coil 122, and a radial direction is perpendicular to the extension direction.

The magnetic circuit assembly 110 may cause the coil 122 to be in a stable magnetic gap. For example, the first magnet 212 in the magnetic circuit assembly 110 may generate a magnetic field that acts on the coil 122. A spatial position of the magnetic gap may include a spatial region enclosed by the magnetic guide cover 211 and the first magnet 212. The first magnet 212 may be a permanent magnet. For example, the first magnet 212 may include a neodymium iron boron magnet, a ferrite magnet, an alnico magnet, or the like. In some embodiments, the first magnet 212 may be shaped as a cylinder, an ellipsoid, or the like. In some embodiments, at least a portion of the first magnet 212 may be disposed in a ring structure enclosed by the coil assembly 120. For example, there is a gap between the first magnet 212 in FIG. 2, the coil support 121, and the coil 122 of the coil assembly 120. The exemplary gap may be 0.3 mm.

The magnetic guide cover 211 may change a magnetic field distribution and create a magnetic shield. The magnetic guide cover 211 prevents the first magnet 212 from radiating a magnetic field outward. The magnetic guide cover 211 may be a structure having a cavity. The cavity may be configured to accommodate other components of the magnetic circuit assembly 110 and the coil assembly 120. The magnetic guide cover 211 may be made of a material with a high magnetic permeability, such as soft iron, silicon steel, pozzolanic alloys, ferro-aluminum alloys, or the like. The magnetic guide cover 211 may increase a strength of the magnetic field of the first magnet 212 at the coil assembly 120 and avoid interference of the magnetic field with other components outside.

The vibration transmitting sheet 214 may vibrate under the drive of the coil assembly 120 and transmit the vibration to a housing of the loudspeaker 100. Further, the vibration of the housing is transmitted to auditory nerves of a user through the bones of the user's head, etc., to produce sound. In some embodiments, as shown in FIG. 2, at least a portion of the vibration transmitting sheet 214 may be connected with the coil support 121. It should be noted that a direct connection between the vibration transmitting sheet 214 and the magnetic circuit assembly 110 (e.g., the first magnet 212 or the magnetic guide cover 211) illustrated in FIG. 2 is only exemplary, and that the vibration transmitting sheet 214 may be connected with the magnetic circuit assembly 110 (e.g., the first magnet 212 or the magnetic guide cover 211) through other connection structures, which are not limited herein.

The coil 122 in the coil assembly 120 vibrates under an action of the electrified current and the external magnetic field and transmits the vibration to the vibration transmitting sheet 214. The coil support 121 may be configured to support the coil 122. In some embodiments, the coil support 121 has an extended end extending toward the magnetic gap. The extended end has a first step structure. The extended end of the coil support 121 in FIG. 2 may extend in a vertically downward (e.g., downwardly extending) direction. The first step structure may be a step structure in the coil support 121 that contacts the coil 122. As shown in FIG. 2, in an example that the first step structure includes two sections of steps, assuming that an A-A cross-section (a cross-section at ½ of a height difference between the inner coil 122-2 and the outer coil 122-1 along an extension direction of the coil support 121) is taken as the reference plane, the first step structure may include a raised portion and a recessed portion, the raised portion may be a step that vertically passes down through the A-A cross-section (e.g., a portion of the coil support 121 near the outer coil 122-1 shown in FIG. 2), and the recessed portion may be a step that does not reach the A-A cross-section (e.g., the portion of the coil support 121 near the inner coil 122-2 shown in FIG. 2). The raised portion and the recessed portion of the first step structure are connected by a transition side parallel to the extension direction. In some embodiments, the raised portion of the first step structure is in contact with the outer coil 122-1 of the coil 122, the recessed portion of the first step structure is in contact with the inner coil 122-2 of the coil 122, and the transition side between the raised portion and the recessed portion of the first step structure is in contact with the inner coil 122-2 of the coil 122. In some embodiments, the coil support 121 may be in the shape of a circle, a hollow cylinder, a hollow elliptical cylinder, or the like. The space in the center of the coil support 121 may be configured to accommodate the magnetic circuit assembly 110. For example, the space in the center of the coil support 121 may be configured to accommodate the magnet, the magnetic guide plate, or the like. In some embodiments, the material of the coil support 121 may be kraft paper, asbestos paper, polyimide, aluminum foil, copper foil, fiberglass, or the like.

The coil 122 may include an outer coil 122-1 and an inner coil 122-2. The inner coil 122-2 is disposed on the inner side of the coil 122 and close to the first magnet 212 in the radial direction illustrated in FIG. 2, and the outer coil 122-1 is disposed on the outer side of the coil 122 and away from the first magnet 212. In a direction close to the coil support 121 (e.g., an upwardly extending direction of FIG. 2), the outer coil 122-1 and the inner coil 122-2 form a second step structure, with the first step structure fitted to the second step structure to allow the coil 122 to be fixedly mounted on the coil support 121. The second step structure may be a step structure in the coil 122 in contact with the coil support 121. In some embodiments, a height of the inner coil 122-2 is greater than a height of the outer coil 122-1 in an extension direction of the coil support 121. In an example that the second step structure includes two steps, assuming that the A-A cross-section (the cross-section at ½ of the height difference between the inner coil 122-2 and the outer coil 122-1 along the extension direction of the coil support 121) is taken as a reference plane, the second step structure may also include a raised portion and a recessed portion, and the raised portion of the second step structure may be a step that passes vertically upwardly through the A-A cross-section (e.g., a portion of the inner coil 122-2 near the coil support 121 in FIG. 2). In some embodiments, the raised portion of the second step structure is in contact with the recessed portion of the first step structure. The recessed portion of the second step structure may be a step below the A-A cross-section (e.g., the portion of the outer coil 122-1 in FIG. 2 that is near the coil support 121). The raised portion of the second step structure and the recessed portion of the second step structure are connected to each other by a transition side parallel to the extension direction. In some embodiments, the recessed portion of the second step structure is in contact with the raised portion of the first step structure, the raised portion of the second step structure is in contact with the recessed portion of the first step structure, and the transition side of the second step structure is in contact with the transition side of the first step structure. In some embodiments, the first step structure and the second step structure may be bonded by adhesion. For example, the portion of the first step structure fitted to the second step structure may be adhesively fixed by an adhesive, such as silicone. In the present embodiment, by setting the height of the inner coil 122-2 greater than the height of the outer coil 122-1 and setting the first step structure of the coil support 121 so that the coil 122 and the coil support 121 not only have a contact area at the raised portion and the recessed portion, respectively, but also contact each other at the transition sides of the two step structures. Thus, the contact area between the coil support 121 and the coil 122 may be increased, the firmness of the bonding between the coil support 121 and the coil 122 may be improved, or the probability of the coil 122 being dislodged from the coil support 121 along the extension direction in the process of vibration may be reduced. Furthermore, the coil support 121 may constitute a stress constraint on the coil 122 in the radial direction, thereby avoiding misalignment of the coil 122 along the radial direction in the vibration process. It should be noted that the outer coil 122-1 and the inner coil 122-2 may be coils wound with the same wire, and there is a distinction between the inner coil and the outer coil due to the different positions of winding.

In some embodiments, a width of the inner coil 122-2 may be the same as a width of the outer coil 122-1 along the radial direction. For example, a width of the raised portion of the second step structure in FIG. 2 is the same as a width of the recessed portion along the radial direction. At this time, in an example that the inner coil 122-2 and the outer coil 122-1 are wound with the same wire, the count of windings of the inner coil 122-2 in the radial direction is the same as that of the outer coil 122-1 in the radial direction. Correspondingly, the width of the recessed portion and the width of the raised portion of the first step structure may also be the same to achieve a size match with the second step structure. The width of the inner coil 122-2 is the same as the width of the outer coil 122-1 in the radial direction, and the width of the recessed portion is the same as the width of the raised portion of the first step structure of the coil support 121 in the radial direction, thereby facilitating the winding of the coil 122 and the fabrication of the coil support 121.

In some embodiments, the coil 122 may be a metal wire with an elongation of not less than 20%. Exemplary metal wires may include copper alloy wires. Adopting a wire with a certain elongation (e.g., an elongation of not less than 20%) allows the coil 122 to be processed in a pre-elongating manner during a winding process, which results in good adhesion of the wires in the coil 122, a stable bonding between the coil 122 and the coil support 121, an improved firmness of the bonding of the coil support 121 with the coil 122, and a reduction of the possibility of the coil 122 falling off from the coil support 121 along the extension direction during the vibration, thereby increasing reliability. Specific descriptions regarding the coil winding process may be found in FIG. 8 and its related descriptions. Additionally, the use of a copper alloy wire with the elongation of not less than 20% avoids tensile breakage or affecting the tensile strength of the coil 122 when the coil is used for pre-elongating due to insufficient ductility. Exemplary copper alloy wires may have an elongation of 20%, 30%, 40%, or the like. In some embodiments, the copper alloy wire may include a nickel-copper alloy wire, a zirconium-copper alloy wire, or the like. It should be noted that elongation refers to the ratio of an increase in the length of the metal wire to an original length. In the present disclosure, the elongation of the metal wire may be measured by the IEC 60851-3 standard. For example, in the tensile instrument or tensile testing machine, a metal wire with a test length within a range of 200 mm-250 mm is stretched to break at a rate of (5±1) mm/s, a ratio of the added length after break and the original length is calculated, the test is performed 3 times to take an average, and the average is the elongation of the metal wire.

In some embodiments, in order to avoid collision caused by a too small distance between a bottom portion of the coil 122 and a bottom surface of an interior of the magnetic guide cover 211 (e.g., the distance between the bottom portion of the coil 122 and the bottom surface of the interior of the magnetic guide 211 along the extension direction of the coil support may be not less than 0.9 mm, which satisfies the requirements of H_{L}=4.4 mm−(H₂+1.7 mm)≥0.9 mm. 4.4 mm denotes a dimension of the magnetic guide cover 211 of the loudspeaker 100 along the extension direction of the loudspeaker 100, and 1.7 mm denotes a distance between the reference plane A-A and a lowest end of the bottom portion of the coil support 121 near the magnetic guide cover 211), and in order to satisfy the requirements of a machining process of the coil support 121 and strength requirements (e.g., a distance between a lower step surface of the coil support 121 and a top portion of the coil support 121 back away from an alignment direction (e.g., a height of the lowest step surface of the coil support 121 along the alignment direction) is not less than 0.5 mm (H_{H}=H₂−H₁≥0.5 mm)), the loudspeaker 100 has a large coil driving force factor BL, and according to the above two conditions, a step parameter H1 and a height position parameter H2 of the coil 122 may satisfy H₁+0.5 mm≤H₂≤1.8 mm, where the step parameter H₁ is ½ of the height difference between the inner coil 122-2 and the outer coil 122-1 along the extension direction of the coil support 121, and the height position parameter H₂ is the distance between the reference plane A-A and the top portion of the coil support 121 back away from the alignment direction. In some embodiments, the reference plane A-A is a plane where ½ of the height difference between the inner coil 122-2 and the outer coil 122-1 along the extension direction of the coil support 121 is located. It should be noted that the dimension of 4.4 mm along the extension direction of the magnetic guide cover 211 of the loudspeaker 100 used to qualify the step parameter H₁ and the height position parameter H₂ of the coil 122, and the distance 1.7 mm between the reference plane A-A and the lowest end of the bottom portion of the coil support 121 close to the magnetic guide cover 211 are only exemplary, and the person skilled in the art may adjust the parameters according to the actual needs, which are further used to determine the relationship between the step parameter H₁ and the height position parameter H₂ of the coil 122.

In some embodiments, a too small step parameter H₁ may result in a small contact area between the coil support 121 and the coil 122. The coil support 121 and the coil 122 are not fixedly connected. A too large step parameter H₁ may result in that the portion of the inner coil 122-2 beyond the reference plane A-A in the extension direction is too long, causing most inner coils 122-2 to be beyond the range of the strongest magnetic field, affecting the sensitivity of the coil. Therefore, to consider the fact that the coil support 121 has a large contact area with the coil 122 and that most inner coils 122-2 are located in the range of the strongest magnetic field (e.g., taking into account both the reliability and the sensitivity), the step parameter H₁ may be within a range of 0.1 mm-0.8 mm. For example, the step parameter H₁ may be within a range of 0.2 mm-0.7 mm. As another example, the step parameter H₁ may be within a range of 0.3 mm-0.6 mm. Furthermore, for example, the step parameter H₁ may be within a range of 0.4 mm-0.5 mm. As yet another example, the step parameter H₁ may be within a range of 0.1 mm-0.4 mm.

In some embodiments, to ensure that the coil support 121 has a certain mechanical strength and prevent the coil support 121 from mechanical damage due to vibration of the coil 122, the coil support 121 needs to have a certain thickness to maintain the mechanical strength of the coil support 121, and at the same time, the coil support 121 has a certain thickness may be conveniently machined, and the distance H_{H} between the lower step surface of the coil support 121 and the coil support and the top portion of the coil support back away from the alignment direction (e.g., the height of the lower step surface of the coil support 121 along the alignment direction) is not less than 0.5 mm. As shown in FIG. 2, a distance H_{H} between a higher step surface of the second step structure along the alignment direction and the top portion of the coil support back away from the alignment direction may be characterized by a difference between the step parameter H₁ and the height position parameter H₂. For example, H_{H}=H2−H1≥0.5 mm. For example, the distance H_{H} between the higher step surface of the second step structure along the alignment direction and the top portion of the coil support back away from the alignment direction is not less than 0.6 mm. For example, the distance H_{H} between the higher step surface of the second step structure along the alignment direction and a top portion of the coil support back away from the alignment direction is not less than 0.8 mm.

In some embodiments, a too large height position parameter H₂ or a too small height position parameter H₂ may result in a decrease in the value of the coil driving force factor BL, which affects the sensitivity of the loudspeaker 100, and thus in order to improve the sensitivity of the loudspeaker 100, the height position parameter H₂ may be within a range of 1.1 mm-1.6 mm. For example, the height position parameter H₂ may be within a range of 1.2 mm-1.5 mm. As another example, the height position parameter H₂ may be within a range of 1.3 mm-1.4 mm.

In some embodiments, to avoid collision during vibration due to the too small distance between the bottom portion of the coil 122 and the bottom surface of the interior of the magnetic guide cover 211, the distance between the bottom portion of the coil 122 and the bottom surface of the interior of the magnetic guide cover 211 along the extension direction of the coil support 121 may be not less than 0.9 mm. For example, the distance between the bottom of the coil 122 and the bottom surface of the interior of the magnetic guide cover 211 along the extension direction of the coil support 121 may be not less than 1 mm.

In some embodiments, a smaller magnetic gap results in a higher coil driving force factor BL value or a higher sensitivity, but a too small magnetic gap results in the coil 122 colliding with the magnetic circuit assembly 110. Thus, in order to take into account the high coil driving force factor BL value or the high sensitivity and to avoid the coil 122 from colliding with the magnetic circuit assembly 110, a gap between the coil 122 and the first magnet 212 along the radial direction may be within a range of 0.25 mm-0.35 mm. For example, the gap between the coil 122 and the first magnet 212 along the radial direction may be within a range of 0.28 mm-0.32 mm.

FIG. 3 is a schematic diagram illustrating another exemplary loudspeaker according to some embodiments of the present disclosure.

As shown in FIG. 3, the coil assembly 120 may include a coil support 121 and a coil 122. The coil 122 includes an outer coil 122-1 and an inner coil 122-2. In some embodiments, along the extension direction of the coil support 121, the height of the inner coil 122-2 may be less than the height of the outer coil 122-1. As shown in FIG. 3, taking the first step structure including two steps as an example and assuming that the A-A cross-section (a cross-section at ½ of the height difference between the inner coil 122-2 and the outer coil 122-1 along the extension direction of the coil support 121) is taken as a reference plane, the first step structure may include a raised portion and a recessed portion. The raised portion of the first step structure may be a step vertically down through the A-A cross-section (e.g., the portion of the coil support 121 near the inner coil 122-2 shown in FIG. 3), and the recessed portion of the first step structure may be a step that does not reach the A-A cross-section (e.g., the portion of the coil support 121 near the outer coil 122-1 shown in FIG. 3). The raised portion of the first step structure is connected with the recessed portion of the first step structure by a transition side parallel to the extension direction. In some embodiments, the raised portion of the first step structure may be in contact with the inner coil 122-2, the recessed portion of the first step structure may be in contact with the outer coil 122-1, and the transition side between the raised portion and the recessed portion is in contact with the outer coil 122-1 of the coil 122. The second step structure may also include a raised portion and a recessed portion, and the raised portion of the second step structure may be a step that passes vertically upwardly through the A-A cross-section (e.g., the portion of the outer coil 122-1 that is close to the coil support 121 in FIG. 3). In some embodiments, the raised portion of the second step structure is in contact with the recessed portion of the first step structure. The recessed portion of the second step structure may be a step below the A-A cross-section (e.g., the portion of the inner coil 122-2 in FIG. 3 that is near the coil support 121). The raised portion of the second step structure is connected with the recessed portion of the second step structure by a transition side parallel to the extension direction. In some embodiments, the recessed portion of the second step structure is in contact with the recessed portion of the first step structure, the raised portion of the second step structure is in contact with the recessed portion of the first step structure, and the transition portion of the second step structure is in contact with the transition portion of the first step structure. In some embodiments, the first step structure and the second step structure may be bonded by adhesion. For example, the fitted portions of the first step structure and the second step structure may be adhesively fixed by an adhesive, such as silicone. In the present embodiment, by setting the height of the inner coil 122-2 to be less than the height of the outer coil 122-1 and setting the first step structure of the coil support 121, the coil 122 and the coil support 121 not only have a contact area at the raised portion and the recessed portion, respectively, but also contact each other at the transition sides of the two step structures, thus realizing the function similar to that of the step structure in FIG. 2. In other words, the contact area of the coil support 121 with the coil 122 is increased, the firmness of the bonding of the coil support 121 with the coil 122 is increased, and the possibility of the coil 122 falling off from the coil support 121 along the extension direction during vibration is reduced. Furthermore, the coil support 121 may constitute a stress constraint on the coil 122 in the radial direction, thereby avoiding misalignment of the coil 122 in the radial direction in the vibration process.

FIG. 4 is a schematic diagram illustrating another exemplary loudspeaker according to some embodiments of the present disclosure. FIG. 5 is a schematic diagram illustrating another exemplary loudspeaker according to some embodiments of the present disclosure.

As shown in FIG. 4 or FIG. 5, the magnetic circuit assembly 110 may include a magnetic guide cover 211, a first magnet 212, a second magnet 413, and a magnetic guide plate 415. In some embodiments, the magnetic guide plate 415 is disposed between the first magnet 212 and the second magnet 413, and the first magnet 212 is magnetically opposite to the second magnet 413. Providing the magnetic guide plate 415 between the first magnet 212 and the second magnet 413 of opposite magnetic properties, so that the magnetic inductance density is the highest and the magnetic field is the strongest at two sides of the magnetic guide plate 415 along the radial direction and the magnetic field. When the region where the density of the coil 122 is the highest is located at the two sides of the magnetic guide plate 415 along the radial direction, the coil driving force factor BL is great, which in turn makes the sensitivity of the loudspeaker 100 great. In some embodiments, the first magnet 212, the magnetic guide plate 415, and the second magnet 413 may be connected by connectors (e.g., screws). The coil assembly 120 may include a coil support 121 and coil 122. The coil 122 includes an outer coil 122-1 and an inner coil 122-2.

In some embodiments, the height of the inner coil 122-2 is greater than the height of the outer coil 122-1 in the extension direction of the coil support 121, referring to FIG. 2, which is not repeated herein. In some embodiments, the width of the outer coil 122-1 along the radial direction is greater than the width of the inner coil 122-2 along the radial direction. For example, the width of the raised portion (e.g., the inner coil 122-2) of the second step structure in FIG. 4 along the radial direction may be less than the width of the recessed portion (e.g., the outer coil 122-1) of the second step structure along the radial direction. Correspondingly, the width of the recessed portion of the first step structure may be smaller than the width of the raised portion of the first step structure to achieve a tight contact between the coil support 121 and the coil 122. In some embodiments, the width of the coil 122 in the radial direction may be 0.6 mm, then the sum of the width of the outer coil 122-1 in the radial direction and the width of the inner coil 122-2 in the radial direction may be 0.6 mm. For example, the width of the outer coil 122-1 in the radial direction may be 0.4 mm and the width of the inner coil 122-2 in the radial direction may be 0.2 mm. Correspondingly, the width of the raised portion of the first step structure along the radial direction may be 0.4 mm, and the width of the recessed portion of the first step structure along the radial direction may be 0.2 mm. The step structure of the coil 122 shown in FIG. 4 may increase the contact area between the coil support 121 and the coil 122, thereby improving the firmness of the bonding between the coil support 121 and the coil 122, reducing the possibility of the coil 122 falling off from the coil 122 along the extension direction during vibration, and improving the reliability of the loudspeaker 100.

As shown in FIG. 5, the width of the raised portion of the second step (e.g., the outer coil 122-1) in the radial direction may be greater than the width of the recessed portion of the second step (e.g., the inner coil 122-2) in the radial direction. Correspondingly, the width of the recessed portion of the first step is greater than the width of the raised portion of the first step to achieve a tight contact between the coil support 121 and the coil 122. In some embodiments, the width of the coil 122 in the radial direction may be 0.6 mm, then the sum of the width of the outer coil 122-1 in the radial direction and the width of the inner coil 122-2 in the radial direction may be 0.6 mm. For example, the width of the outer coil 122-1 in the radial direction may be 0.4 mm and the width of the inner coil 122-2 in the radial direction may be 0.2 mm. Correspondingly, the width of the protruding portion of the first step structure in the radial direction may be 0.2 mm, and the width of the recessed portion of the first step structure in the radial direction may be 0.4 mm. By setting the width of the outer coil 122-1 in the radial direction to be greater than the width of the inner coil 122-2 in the radial direction (as shown in FIG. 5), more portions of the coil 122 may be disposed in the region of maximum magnetic field strength, resulting in a great coil driving force factor BL, and thus great sensitivity of the loudspeaker 100.

By adjusting the widths of the outer coil 122-1 and the inner coil 122-2 in the radial direction in this embodiment, the adaptability of the coil 122 to different shapes of the coil support 121 (e.g., the coil supports with different radial widths of the step structure) may be improved, and the width of the coil may be adjusted in different winding manners. In some embodiments, the count of windings of the inner coil 122-2 may be no less than 3 to ensure that the loudspeaker 100 has a high reliability.

It should be noted that the step structure coils provided in FIG. 2-FIG. 5 of the present disclosure are for illustrative purposes only and are not intended to be a limitation of the number of steps. For example, the step structure coil may also be a structure including 3 steps, 4 steps, or the like. Corresponding coil supports may also be structures that include 3 steps, 4 steps, etc. As another example, the transition side in the step structure may form any angle (not limited to 90° in FIG. 2-FIG. 5) with the recessed or raised portion. As another example, the width of the inner coil 122-2 along the radial direction may be greater than the width of the outer coil 122-1 along the radial direction, thereby achieving the same effect of increasing the contact of the coil support 121 with the coil 122 area. At this time, when the height of the inner coil is greater than the height of the outer coil 122-1 in the extension direction of the inner coil along the coil support 121, a large portion of the coil 122 is located in the region of maximum magnetic field strength, resulting in a great coil driving force factor BL, and thus great sensitivity of the loudspeaker 100.

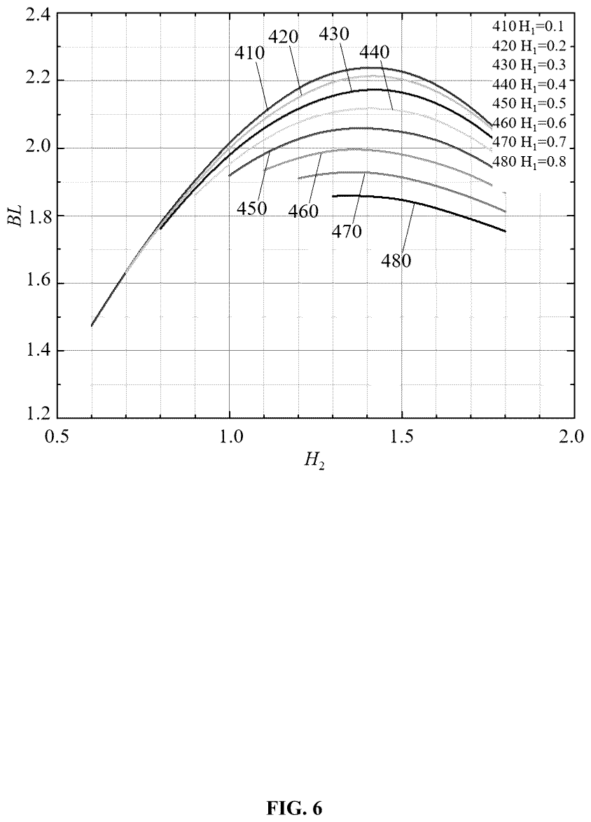

FIG. 6 is a curve illustrating a relationship between a coil driving force factor BL and a height position parameter H₂ for different step parameters H₁ according to some embodiments of the present disclosure.

As shown in FIG. 6, when any one of the step parameter H₁ and the height position parameter H₂ is changed, the coil driving force factor BL is changed. Curve 410 illustrates a relationship between the height position parameter H₂ and the coil driving force factor BL when the step parameter H₁ is 0.1 mm. With the increase of the height position parameter H₂, the coil driving force factor BL increases to a peak value and then decreases gradually. From testing, the coil driving force factor BL is higher when the height position parameter H₂ is within a range of 1.1 mm-1.6 mm. Thus, coils in this range have a higher sensitivity. Descriptions regarding curve 420, curve 430, curve 440, curve 450, curve 460, curve 470, and curve 480 may be referred to as the description of curve 410. It should be noted that as the step parameter H1 increases, there is less room for the coil drive factor BL to grow. As in curve 460, curve 470, and curve 480, segments of the curve in which the coil driving force factor BL increases with the increase in the height position parameter H₂ are short, that is, the coil driving force factor BL reaches the peak value rapidly and then begins to decline.

As shown in FIG. 6, when the height position parameter H₂ is certain, the greater the step parameter H₁ is, the smaller the peak value of the coil driving force factor BL is. The peak value of the coil driving force factors BL of curve 410, curve 420, curve 430, curve 440, curve 450, curve 460, curve 470, and curve 480 decrease in order. The coil driving force factor BL is tested to be great when the step parameter H₁ is within a range of 0.1 mm-0.4 mm, that is the sensitivity of the coil in the range of 0.1 mm-0.4 mm is high.

From the above curvilinear relationship, it can be seen that in order to increase the sensitivity of the coil (e.g., coil driving force factor BL), the height of the second step structure of the coil (e.g., step parameter H₁) may be minimized while ensuring the reliability of the coil and the distance between the reference plane and the top portion of the coil support back away from the alignment direction (e.g., the height position parameter H₂) may be chosen to be within a range of 1.1 mm-1.6 mm.

FIG. 7 is a cross-sectional view in a radial direction of a coil according to some embodiments of the present disclosure. The radial direction of the coil refers to a direction from the center of the coil outward.

In some embodiments, in order to ensure a bonding strength within the coil 122, and a bonding strength between the coil 122 and the coil support 121, and to further improve the bond reliability, the coil 122 may be made of a high-tensile wire having an adhesive layer. It should be understood that high-tensile wire described in the present disclosure refers to a wire in which the elongation of the coil 122 is greater than a certain threshold (e.g., 20%). For example, the high-tensile wire may have an elongation of 20%, 30%, 40%, or the like. In some embodiments, the high-tensile wire may be made from a copper alloy wire. Exemplary copper alloy wires may include nickel-copper alloy wires, zirconium-copper alloy wires, or the like. In some embodiments, the coil 122 may be realized by the coil 700 shown in FIG. 7.

In some embodiments, as shown in FIG. 7, the coil 700 may include a conductor 710, an insulating layer 720, and an adhesive layer 730, respectively, in a radial direction of the coil from inside to outside. In some embodiments, the diameter of the high-tensile wire may be within a range of 0.08 mm-0.12 mm. For example, the diameter of the high-tensile wire may be 0.1 mm. In some embodiments, a sum of a thickness of the insulating layer 720 and a thickness of the adhesive layer 730 (e.g., the thickness of the skin) along the radial direction of the coil 700 may be not less than 0.016 mm. For example, the thickness of the insulating layer 720 may be not less than 0.008 mm along the radial direction of the coil 700, and the thickness of the adhesive layer 730 may be not less than 0.008 mm along the radial direction of the coil 700.

The conductor 710 refers to a portion of coil 700 configured to conduct electricity. An exemplary conductor may include a copper wire, an aluminum wire, a copper-clad aluminum wire, a copper alloys, or the like. The insulating layer 720 refers to a portion coated or wrapped around the periphery of the conductor 710 for electrical insulation. Materials of an exemplary insulating layer may include polyethylene, polyvinyl chloride, cross-linked polyethylene, natural rubber-styrene-styrene adhesive blends, ethylene propylene rubber, butyl rubber, or the like.

The adhesive layer 730, also referred to as a self-fusing layer, refers to an adhesion layer that is attached to the insulating layer 720 by coating, immersion, or the like. The adhesive layer 730 is located in an outermost layer of the coil 700. Materials of an exemplary adhesive layer may include polyvinyl butyral resins, modified polyamides, alcohol-based modified polyamides, hot air bonded polyamides, or the like.

In the loudspeaker 100 described in some embodiments of the present disclosure, the elongation of the coil 122 is greater than a certain threshold (e.g., 20%) to make the bonding between the coil 122 and the coil support 121 stable, to improve the firmness of the bonding between the coil support 121 and the coil 122, and to reduce the possibility that the coil 122 falling off from the coil support 121 along the extension direction during vibration, thereby increasing the reliability of the loudspeaker 100.

FIG. 8 is a schematic diagram illustrating a coil arrangement according to some embodiments of the present disclosure.

In some embodiments, the coils may be pre-tensioned before the coils are wound. A pre-tensioning may make the coil fully extended and improve a shape stability of the coil after winding. The pre-tensioning may make the coil extend to a certain extent based on the elongation (e.g., a copper alloy wire with an elongation of not less than 20% provided in the present disclosure), thereby avoiding that the wires may be extended again under the action of external force and destroying the stability of the winding later. Additionally, the pre-tensioning increases the pressure and friction between the layers of the coils, further improving coil shape stability.

FIG. 8 is a schematic diagram of an arrangement of the right half of a coil of the step structure in FIG. 2 after rotating 90° counterclockwise. As shown in FIG. 8, the wire of the coil 122 is wound around the magnet (e.g., the first magnet 212) starting from number 1 and lined up back and forth in three layers to number 53 (the first layer is lined up from number 1 to number 18, the second layer is lined up from number 19 to number 35, and the third layer is lined up from number 36 to number 53), and the coils of the above numbers 1 to 53 may be used as the inner coil 122-2. Then, by extending a positioning mold 810 on the left side by a specific length (for example, the specific length may be 2 times the step parameter H1) to control the heights of the fourth, fifth, and sixth layers, these three layers are wound back from number 54 up to number 79, and the coils from number 54 to number 79 described above may be used as the outer coils 122-1. In some embodiments, by controlling the number of layers of the outer coil, and the number of layers of the inner coil, the width of the outer coil and the width of the inner coil along the radial direction may be controlled. For example, the inner coil 122-2 of the coil 122 in FIG. 4 may be a coil including the first and second layers, and the outer coil 122-1 may be a coil including the third, fourth, fifth, and sixth layers. The above arrangement process may make the step less prone to misalignment or unevenness within the layers and ensure the shape stability at the step.

Similarly, for the coils of the step structure of FIG. 3, the winding may be carried out in such a way that the positioning mold 810 is first made to extend a specific length (e.g., the specific length may be 2 times the step parameter H₁) along the first magnet 212 to control the heights of the first, second, and third layers. Then the coil support is placed for four, five, or six layers of winding. In some embodiments, by controlling the number of layers of the outer coil and the number of layers of the inner coil, it is possible to control the width of the outer coil and the width of the inner coil along the radial direction. For example, the inner coil 122-2 of the coil 122 in FIG. 5 may be a coil including the first and second layers, and the outer coil 122-1 may be a coil including the third, fourth, fifth, and sixth layers.

It should be noted that the number of layers of the coil and coil number in FIG. 8 are for convenience of illustration only and are not intended to be a limitation on the number of coil layers and the number of coils (or the count of windings) wound around the coil. For example, the coils may be wound 5 layers, 8 layers, 18 layers, etc. The count of windings of the coil may be 100, 101, 150, etc.

The embodiments of the present disclosure include, but are not limited to the following beneficial effects: (1) the contact area between the coil and the coil support is increased by setting the coil and the coil support with step structures, the stability of the coil is improved, and at the same time, the possibility of the coil falling off in the radial direction is decreased. (2) by pre-tensioning before winding, the pressure and friction between the layers of the coil are increased, to enhance the internal bonding strength of the coil and improve the space utilization. (3) by the use of high-tensile wire as the coil wire, the bonding strength between the coil and the coil support is increased, and the stacking firmness of the wires that are contact with each other in the coil is increased through the adhesive layer on the surface of the high-tensile wire. It should be noted that beneficial effects that may be produced by different embodiments are different, and the beneficial effects that may be produced in different embodiments may be any one or a combination of any of the foregoing, or any other beneficial effect that may be obtained.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A loudspeaker, comprising:
a magnetic circuit assembly;
a coil assembly, wherein at least a portion of the coil assembly is provided in a magnetic gap formed by the magnetic circuit assembly, the coil assembly is electrified to drive a vibrating member to vibrate to produce sound, and the coil assembly includes:
a coil support having an extended end extending toward the magnetic gap, the extended end having a first step structure; and
a coil including an outer coil and an inner coil, the outer coil and the inner coil forming a second step structure in a direction close to the coil support, and the first step structure and the second step structure are fitted to each other so that the coil is fixedly mounted on the coil support, wherein
a distance between a lower step surface of the coil support and a top portion of the coil support back away from an alignment direction is not less than 0.5 mm.

2. The loudspeaker of claim 1, wherein a height of the inner coil is greater than a height of the outer coil along an extension direction of the coil support.

3. The loudspeaker of claim 1, wherein a height of the inner coil is less than a height of the outer coil along an extension direction of the coil support.

4. The loudspeaker of claim 1, wherein a width of the inner coil is the same as a width of the outer coil along a radial direction.

5. The loudspeaker of claim 1, wherein a width of the outer coil is greater than a width of the inner coil along a radial direction.

6. The loudspeaker claim 1, wherein the coil is a metal wire with an elongation of no less than 20%.

7. The loudspeaker of claim 1, wherein the coil includes a conductor, an insulating layer, and an adhesive layer, respectively, in a radial direction of the coil from inside to outside, and a sum of a thickness of the insulating layer and a thickness of the adhesive layer is not less than 0.016 mm.

8. The loudspeaker of claim 1, wherein a step parameter H₁ and a height position parameter H₂ of the coil satisfy H₁+0.5 mm≤H₂≤1.8 mm, the step parameter H₁ is ½ of a height difference between the inner coil and the outer coil along an extension direction of the coil support, and the height position parameter H₂ is a distance between a reference plane and a top portion of the coil support back away from an alignment direction, and the reference plane is a plane where ½ of the height difference between the inner coil and the outer coil along the extension direction of the coil support is located.

9. The loudspeaker of claim 8, wherein the step parameter H₁ is within a range of 0.1 mm-0.8 mm.

10. The loudspeaker of claim 8, wherein the height position parameter H₂ is within a range of 1.1 mm-1.6 mm.

11. (canceled)

12. The loudspeaker of claim 1, wherein the magnetic circuit assembly includes a first magnet and a magnetic guide cover disposed at least partially around the first magnet, and along the extension direction of the coil support, a distance between a bottom portion of the coil and a bottom surface of an interior of the magnetic guide cover is not less than 0.9 mm.

13. The loudspeaker of claim 12, wherein a gap between the coil and the first magnet in a radial direction is within a range of 0.25 mm-0.35 mm.

14. The loudspeaker of claim 12, wherein the magnetic circuit assembly further includes a second magnet and a magnetic guide plate, the magnetic guide plate is disposed between the first magnet and the second magnet, and the first magnet and the second magnet are of opposite magnetic properties.

15. A loudspeaker, comprising:
a magnetic circuit assembly;
a coil assembly, wherein at least a portion of the coil assembly is provided in a magnetic gap formed by the magnetic circuit assembly, the coil assembly is electrified to drive a vibrating member to vibrate to produce sound, and the coil assembly includes:
a coil support having an extended end extending toward the magnetic gap; and
a coil including an outer coil and an inner coil, the outer coil and the inner coil forming a step structure in a direction close to the coil support, and the coil is a metal wire with an elongation of no less than 20%.

16. The loudspeaker of claim 15, wherein the coil includes a conductor, an insulating layer, and an adhesive layer, respectively, in a radial direction of the coil from inside to outside, and a sum of a thickness of the insulating layer and a thickness of the adhesive layer is not less than 0.016 mm.

17. The loudspeaker of claim 15, wherein a height of the inner coil is greater than a height of the outer coil along an extension direction of the coil support.

18. The loudspeaker of claim 15, wherein a height of the inner coil is less than a height of the outer coil along an extension direction of the coil support.

19. The loudspeaker of claim 15, wherein a width of the inner coil is the same as a width of the outer coil along a radial direction.

20. The loudspeaker of claim 15, wherein a width of the outer coil is greater than a width of the inner coil along a radial direction.

21. The loudspeaker of claim 15, wherein a step parameter H₁ and a height position parameter H₂ of the coil satisfy H₁+0.5 mm≤H₂≤1.8 mm, the step parameter H₁ is ½ of a height difference between the inner coil and the outer coil along an extension direction of the coil support, and the height position parameter H₂ is a distance between a reference plane and a top portion of the coil support back away from an alignment direction, and the reference plane is a plane where ½ of the height difference between the inner coil and the outer coil along the extension direction of the coil support is located.

22-28. (canceled)
